(19) United States
(12) Patent Application Publication
(10) Pub. No.: US 2026/0186939 A1
(43) Pub. Date: Jul. 2, 2026

(54) IDENTIFYING LATEST DATA UPDATE LOCATIONS IN APPLICATIONS

(71) Applicant: International Business Machines Corporation, Armonk, NY (US)

(72) Inventors: Vitobha Munigala, Secunderabad (IN); Shivali Agarwal, Ghaziabad (IN); Nasser Ebrahim, Bengaluru (IN)

(21) Appl. No.: 19/007,665

(22) Filed: Jan. 2, 2025

(51) Int. Cl. G06F 11/30; G06F 40/30

(52) U.S. Cl. CPC G06F 11/3079; G06F 40/30

(57) ABSTRACT

A computer-implemented method for identifying last update locations of variables in a computer system is provided. A processor set identifies a number of programs invoked by a transaction. The transaction comprises a number of program operations associated with the number of programs in response of a user-input from a user. The processor set performs analysis for the number of programs to generate a transaction diagram. The transaction diagram comprises information associated with the number of programs. The processor set identifies a number of variables for the number of programs using the transaction diagram. The processor set selects a variable from the number of variables to perform a data lineage analysis for the variable. The data lineage analysis traces an entire lifecycle of the variables in the computer system. The processor set identifies a number of last update locations for the variable based on the data lineage analysis.

### BACKGROUND

The disclosure relates generally to identifying latest data update locations in applications.

Latest data update locations, or last update locations of data refer to the point or region in a computer system where the most recent data was recorded or modified. Last update location of data is crucial for ensuring the accuracy and reliability of information. By pinpointing where updates occur, users can validate the authenticity of the data to ensure that the information being used is both relevant and correct.

Identification of last update locations of data is an important feature that can be applied to various fields. For example, tracking update locations are essential for troubleshooting and error detection. In this case, knowledge related to where the most recent updates occurred can be helpful for isolating problems more efficiently when a system issue or data anomaly arises, thereby reducing downtime and maintaining the integrity of the data pipeline.

In addition, identifying a last update location is often a regulatory requirement in industries with strict compliance standards. Being able to track and audit where updates occur provides transparency and accountability. This is especially important in finance and healthcare, where data must be handled with provision to meet legal and ethical standards.

### SUMMARY

According to one illustrative embodiment, a computer-implemented method for identifying last update locations of variables in a computer system is provided. A processor set identifies a number of programs invoked by a transaction. The transaction comprises a number of program operations associated with the number of programs in response of a user-input from a user. The processor set performs analysis for the number of programs to generate a transaction diagram. The transaction diagram comprises information associated with the number of programs for the transaction. The processor set identifies a number of variables for the number of programs using the transaction diagram. The processor set selects a variable from the number of variables to perform a data lineage analysis for the variable. The data lineage analysis traces an entire lifecycle of the variables in the computer system. The processor set identifies a number of last update locations for the variable based on the data lineage analysis. According to other illustrative embodiments, a computer system, and a computer program product for identifying last update location of variables in a computer system are provided.

### BRIEF DESCRIPTION OF THE DRAWINGS

FIG. 1 is a pictorial representation of a computing environment in which illustrative embodiments may be implemented;

FIG. 2 is an illustration of a block diagram of a data management environment in accordance with an illustrative embodiment;

FIG. 3 is an illustration of pseudo code for an algorithm for analyzing transactions in accordance with an illustrative embodiment;

FIG. 4 are illustrations of transaction diagrams in accordance with an illustrative embodiment;

FIG. 5 is an illustration of pseudo code for an algorithm for identifying last update location of a variable in accordance with an illustrative embodiment;

FIG. 6A-6B is an illustration of a lineage graph in accordance with an illustrative embodiment;

FIG. 7 is an illustration of a process for identifying update last location of variables in a computer system in accordance with an illustrative embodiment;

FIG. 8 is an illustration of a process for generating a lineage graph in accordance with an illustrative embodiment;

FIG. 9 is an illustration of a process for identifying the number of programs invoked by the transaction in accordance with an illustrative embodiment;

FIG. 10 is an illustration of a process for identifying the number of variables for the number of programs using the transaction diagram in accordance with an illustrative embodiment;

FIG. 11 is an illustration of a process for identifying the number of variables based on the user intent in accordance with an illustrative embodiment; and

FIG. 12 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one or more storage media (also called “mediums”) collectively included in a set of one or more storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

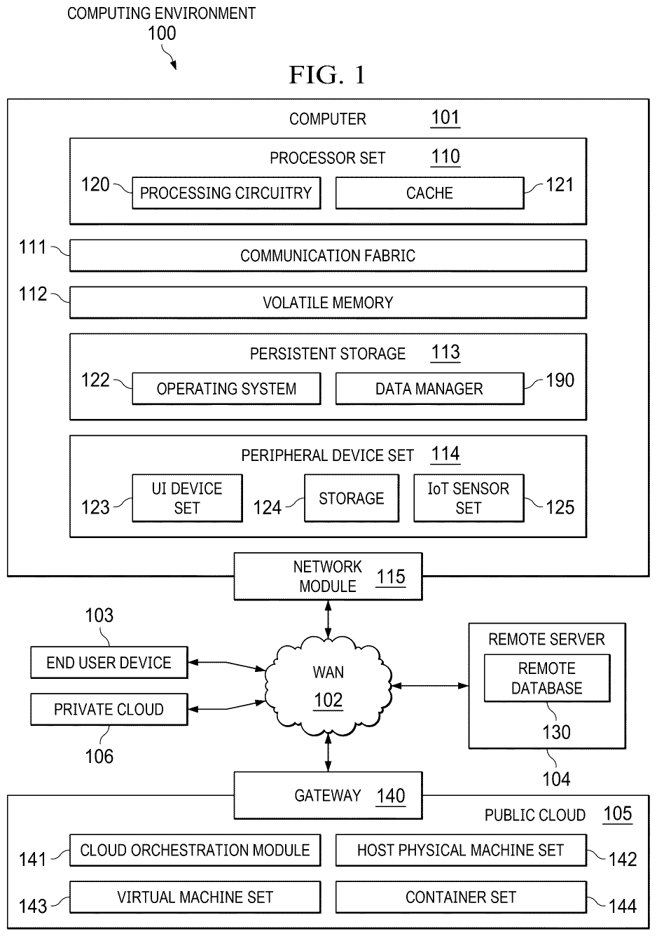

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as data manager 190. In addition to data manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and data manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one or more computer processors of any type now known or to be developed in the future. Processing circuitry 120 may be distributed over multiple packages, for example, multiple coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions and associated data are accessed by processor set 110 to control and direct performance of the inventive methods. In computing environment 100, at least some of the instructions for performing the inventive methods may be stored in data manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in data manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, the illustrative embodiments recognize and take into account that identification of latest data update location is especially important in industries that rely heavily on real-time or near real-time data such as finance and healthcare. The illustrative embodiments recognize and take into account that decision-making in fast paced environments often depends on having access to the most current data. In this case, knowing where the latest updates have been made helps users to ensure that decisions are based on fresh and relevant information.

The illustrative embodiments also recognize and take into account that current technology for solving the problem of data availability from System of Record (SOR) data does not address the availability of data to the application in near-real-time scenarios such as near-real-time transfer of data from legacy SOR systems to cloud applications The illustrative embodiments also recognize and take into account that identification of latest update locations within an application that focuses on particular variables requires tedious manual effort.

Thus, illustrative embodiments of the present invention provide a computer implemented method, computer system, and computer program product for identifying last update locations of variables in a computer system. A processor set identifies a number of programs invoked by a transaction. The transaction comprises a number of program operations associated with the number of programs in response of a user-input from a user. The processor set performs analysis for the number of programs to generate a transaction diagram. The transaction diagram comprises information associated with the number of programs for the transaction. The processor set identifies a number of variables for the number of programs using the transaction diagram. The processor set selects a variable from the number of variables to perform a data lineage analysis for the variable. The data lineage analysis traces an entire lifecycle of the variables in the computer system. The processor set identifies a number of last update locations for the variable based on the data lineage analysis. According to other illustrative embodiments, a computer system, and a computer program product for identifying last update locations of variables in a computer system are provided.

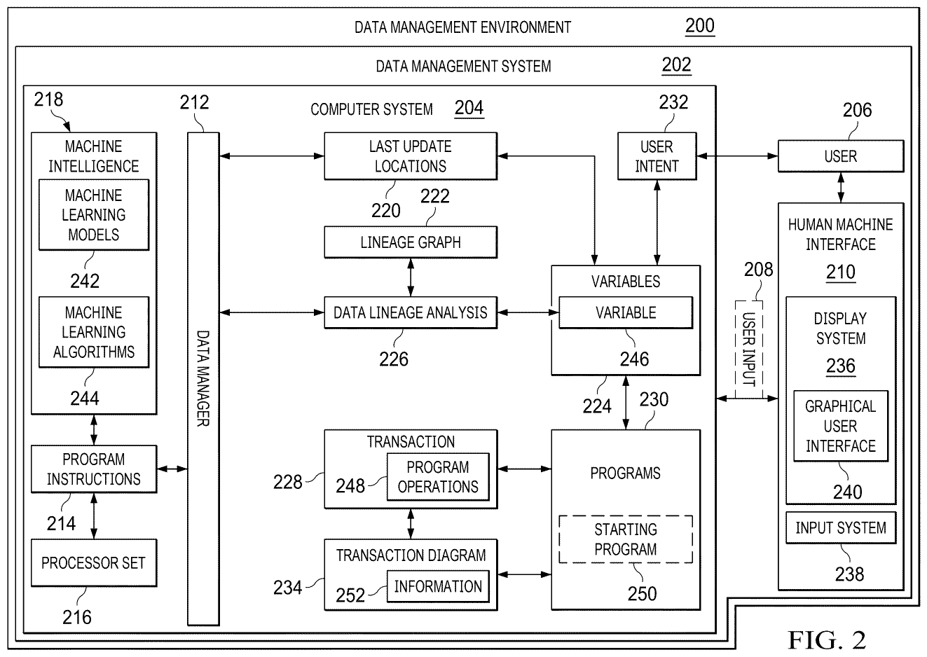

With reference now to FIG. 2, an illustration of a block diagram of a data management environment is depicted in accordance with an illustrative embodiment. In this illustrative example, data management environment 200 includes components that can be implemented in hardware such as the hardware shown in computing environment 100 in FIG. 1.

In this illustrative example, data management system 202 in data management environment 200 can be used to identify last update locations 220 for variable 246. In this illustrative example, data management system 202 includes computer system 204 which includes data manager 212. Data manager 212 is located in computer system 204. Data manager 212 may be implemented using data manager 190 in FIG. 1.

Data manager 212 can be implemented in software, hardware, firmware, or a combination thereof. When software is used, the operations performed by data manager 212 can be implemented in program instructions configured to run on hardware, such as a processor unit. When firmware is used, the operations performed by data manager 212 can be implemented in program instructions and data and stored in persistent memory to run on a processor unit. When hardware is employed, the hardware can include circuits that operate to perform the operations in data manager 212.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 110 in FIG. 1. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

As depicted, computer system 204 includes machine intelligence 218. Machine intelligence 218 can include machine learning models 242 and machine learning algorithms 244. Machine learning models 242 is a branch of artificial intelligence (AI) that enables computers to detect patterns and improve performance without direct programming commands. Rather than relying on direct input commands to complete a task, machine learning models 242 relies on input data. The data is fed into the machine, one of machine learning algorithms 244 is selected, parameters for the data are configured, and the machine is instructed to find patterns in the input data through optimization algorithms. The data model formed from analyzing the data is then used to predict future values.

Machine intelligence 218 is continuously refined over time through trial and error. Equivalence of assets or products can be effectively performed by supervised machine learning so that products or assets that do not match descriptively can nevertheless be matched. Over time, the data model from machine learning can provide a greater degree of flexibility in matching machine intelligence 218.

Machine intelligence 218 can be implemented using one or more systems such as an artificial intelligence system, a neural network, a generative neural network, a Bayesian network, an expert system, a fuzzy logic system, a genetic algorithm, or other suitable types of systems. Machine learning models 242 and machine learning algorithms 244 may make computer system 204 a special purpose computer identifying last update locations 220 for variable 246.

Machine learning models 242 involves using machine learning algorithms 244 to build computation models based on samples of data. The samples of data used for training are referred to as training data or training datasets. Machine intelligence 218 can make predictions without being explicitly programmed to make these predictions. Machine intelligence 218 can be used for training and retraining computation models for a number of different types of applications. These applications include, for example, medicine, financial services, healthcare, speech recognition, computer vision, or other types of applications.

In this illustrative example, machine learning algorithms 244 can include supervised machine learning algorithms and unsupervised machine learning algorithms. Supervised machine learning can train machine learning models using data containing both the inputs and desired outputs. Examples of machine learning algorithms include XGBoost, K-means clustering, and random forest. In addition, machine learning algorithms 244 can also include semi-supervised learning which necessitates human involvement for input validations.

As depicted, data manager 212 can identify last update locations 220 for variable 246. In this illustrative example, last update locations 220 refer to the specific point or location in computer system 204 where the most recent change, addition, or modification to data has occurred.

In this illustrative example, data manager 212 can identify programs 230 invoked by transaction 228. Transaction 228 is a sequence of one or more operations that are treated as a single unit of work. For example, transaction 228 can include program operations 248 associated with programs 230 in response of user input 208 from user 206. In this example, transaction 228 can be analyzed by data manager 212 to obtain transaction context. Transaction context refers to a set of conditions under which transaction 228 is executed. It includes all information, resources, and rules required to process transaction 228.

In this illustrative example, program operations 248 are actions or tasks performed by a program in programs 230 during execution. In this example, program operations 248 can be arithmetic operations, logical operations, data manipulation, control flow operations, input/output operations, or any suitable operations performed by programs 230. In this illustrative example, program operations 248 can be implemented using program instructions 214.

In this illustrative example, programs 230 can be identified in a number of ways. For example, data manager 212 can identify starting program 250 from programs 230 in response to user input 208. In this example, starting program 250 is the first program invoked by transaction 228 in response to user input 208. Subsequently, all programs in programs 230 can be identified based on other programs invoked by starting program 250. In this illustrative example, data manager 212 performs program analysis on starting program 250 to obtain information related to inter program calls, input/output operations in each program invoked by starting program 250. In addition, data manager 212 identifies fields, type of operation, and other information for each input/output operation. Subsequently, a recursive analysis can be performed for each program invoked by starting program 250 to identify programs 230 for transaction 228.

In this illustrative example, data manager 212 can perform analysis for programs 230 to generate transaction diagram 234. Transaction diagram 234 is a visual representation of processes and interactions involved in transaction 228. In this illustrative example, transaction diagram 234 illustrates the flow of information and sequence of operations that make up transaction 228. For example, transaction diagram 234 can include information 252 related to sequence of programs invocation for programs 230 for transaction 228, sequence of input/output operations performed within each program from programs 230 in a sequential fashion, conditional statements associated with the sequence of input/output operations, and commit statements associated with programs 230.

In this illustrative example, data manager 212 identifies a number of variables 224 using transaction diagram 234. The number of variables 224 are variables for programs 230 that have been updated or modified. For example, the number of variables 224 can include variables impacted by input/output operations but are not part of input/output update operations, variables impacted by linkage section variables, variables that are used to update other variables, or any suitable variable for programs 230.

Alternatively, data manager 212 can use machine learning models 242 to identify variables 224. In this illustrative example, data manager 212 first receives user intent 232 in a form of natural language specified by user 206. In this case, data manager 212 uses machine learning models 242 to identify variables 224 that are semantically equivalent to user intent 232.

For example, data manager 212 can split variable names for all variables associated with the programs 230 into a number of chunks. In this example, data manager 212 can use machine learning models 242 to extract contexts from the number of chunks. In addition, data manager 212 can use machine learning models 242 to expand the number of chunks into a number of expanded forms based on the contexts extracted by the machine learning models 242.

Subsequently, data manager 212 uses machine learning models 242 to measure semantic similarities between each expanded form in the number of expanded forms to the user intent. Data manager 212 can identify a set of variables based on the semantic similarities. In this illustrative example, the set of variables corresponds to expanded forms with semantic similarities that exceed a predefined similarity threshold. As a result, data manager 212 can return the set of variables as variables 224.

For example, if variables names are XFRMAT and SRC-ACNT, data manager 212 can split those two variables into chunks of “XFR” and “AMT”, and “SRC” and “ACNT”. In this illustrative example, the chunks can be split by a first machine learning model with a subword tokenization algorithm from machine learning models 242. The chunks can then be inputted into a second machine learning model from machine learning models 242 for context extraction. In this example, context can be the domain, transaction name, program name, or any suitable information such that the information can add additional information to the variable expansion technique.

In this illustrative example, the chunks can be expanded into expanded forms using the context extracted using the second machine learning model from machine learning models 242. For example, “XFR” can be expanded to “Transfer”, “AMT” can be expanded to “Amount”, “SRC” can be expanded to “Source”, and “ACNT” can be expanded to “Account”. Subsequently, data manager 212 can use machine learning models 242 to measure cosine similarity between the expanded forms and user intent 232 and return all variables which exceed a predefined similarity threshold. For example, if user intent 232 is “Balance Variables” and related variables such as “XFRAMT”, “AVLBAL”, and “ACTBAL” can be identified by data manager 212 using machine learning models 242.

In this illustrative example, data manager 212 selects a variable such as variable 246 from variables 224 to perform data lineage analysis 226. Data lineage analysis 226 tracks origins, movements, transformation, modifications, and dependencies of data as data flows through computer system 204. Data lineage analysis 226 provides a clear understanding of where data comes from, how data is processed, and where the data is updated and ultimately used. In other words, data lineage analysis 226 traces the entire lifecycle of variable 246 in computer system 204. As a result, last update locations 220 can be identified for variable 246 using data lineage analysis 226.

In this illustrative example, data manager 212 can identify last update locations 220 for variable 246 in a number of ways. For example, data manager can perform a forward pass based on transaction diagram 234 for transaction 228 to identify a number of control chains where variable 246 is updated. Subsequently, data manager 212 can perform a backward pass for each control chain from the number of control chains to identify last update locations 220.

In this illustrative example, the forward pass involves tracing the sequence of operations or events starting from an initial point in computer system 204 to identify the complete control chain. In addition, backward pass involves tracing the flow of data or operations in reversed order using the control chains to identify last update locations 220 for variables 246.

In this illustrative example, data manager 212 can further generate lineage graph 222 based on data lineage analysis 226 and display lineage graph 222 for variable 246 to show last update locations 220 in a highlighted fashion. In this example, lineage graph 222 is a visual representation of data lineage for variable 246. Lineage graph 222 uses nodes and edges to depict relationships and flow of data between various entities.

In this illustrative example, user 206 can interact with computer system 204 via user input 208. User input 208 can be generated by user 206 using human machine interface (HMI) 210. As depicted, human machine interface 210 includes display system 236 and input system 238. Display system 236 is a physical hardware system and includes one or more display devices on which graphical user interface 240 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, virtual reality headsets, or some other suitable device that can output information for the visual presentation of information.

In this example, user 206 is a person that can interact with graphical user interface 240 through user input 208 generated by input system 238. Input system 238 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device. In this illustrative example, user 206 can view transaction diagram 234, last update locations 220, and lineage graph 222 through graphical user interface 240.

As a result, data manager 212 can perform source code modifications for computer system 204 and programs 230 using last update locations 220 for variable 246 to enhance data collection capability. In addition, last update locations 220 can be cached in memories for fast retrieval.

In one illustrative example, one or more solutions are present that overcome a problem with identifying last update locations for variables in a computer system. As a result, one or more technical solutions may provide an ability to increase the efficiency for identifying last update locations of data in a computer system. In this illustrative example, improvement on efficiency of identifying last update locations for data directly contributes to improved computer functioning by optimizing system responsiveness, reducing resource consumption, and minimizing downtime. A computer system can avoid redundant computations or unnecessary traversals through data or control chains when most recent updates of data can be pinpointed quickly. This improvement in efficiency translates into faster execution of dependent processes, such as error recovery, real-time analytics, and transactional consistency checks.

In addition, hardware functioning can also benefit from faster last update location identification through reduced wear on storage devices, lower power consumption, and better utilization of hardware resources. Optimized update tracking minimizes the need for repeated disk input/output operations, which improves speed and extends the lifespan of storage components. Additionally, caching the latest update metadata in high-speed memory reduces the reliance on slower secondary storage, thereby ensuring faster response times and more efficient use of the hardware stack.

In the illustrative example, computer system 204 can be configured to perform at least one of the steps, operations, or actions described in the different illustrative examples using software, hardware, firmware, or a combination thereof. As a result, computer system 204 operates as a special purpose computer system in which data manager 212 in computer system 204 enables identification of last update locations for data in a quick and efficient manner. In particular, data manager 212 transforms computer system 204 into a special purpose computer system as compared to currently available general computer systems that do not have data manager 212. For example, data manager 212 can be used for identifying last update locations for variables in legacy applications for downstream cloud applications in a quick and efficient manner.

The illustration of data management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, data manager 212 can identify last update locations for multiple variables from variables 224 in parallel.

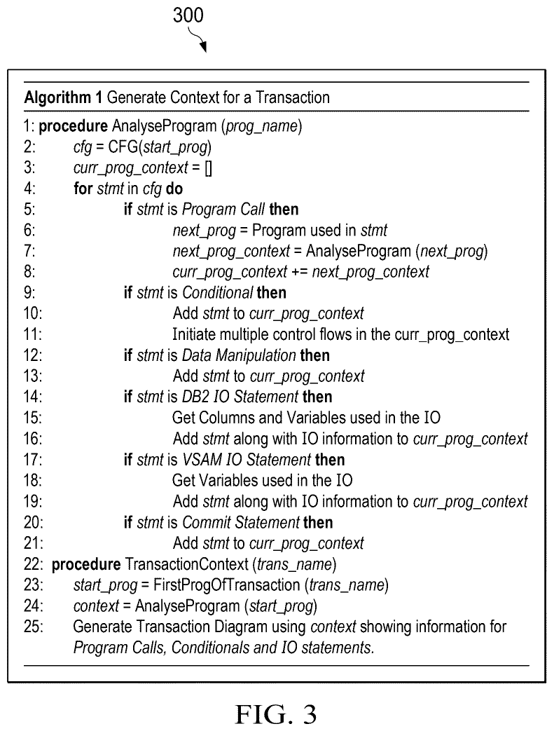

With reference now to FIG. 3, an illustration of pseudo code for an algorithm for analyzing transactions is shown in accordance with an illustrative embodiment. In this example, code 300 in FIG. 3 can be implemented using program instructions 214 in FIG. 2.

In FIG. 3, code 300 illustrates steps for extracting context for a transaction such as transaction 228 in FIG. 2. As depicted in code 300, context for the transaction is extracted based on statements for program calls, conditional statements, statements for data manipulation, input/output statement, and commit statement.

It should be understood that the illustration of code 300 in FIG. 3 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, code 300 can include other programming logic for extracting context from a transaction.

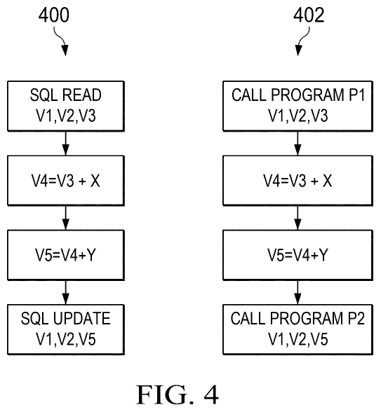

With reference now to FIG. 4, illustrations of operation diagrams are shown in accordance with an illustrative embodiment. In this example, operation diagram 400 and operation diagram 402 can be used for identifying variables for determining last update locations. For example, transaction diagram 400 and transaction diagram 402 can be used for identifying variables 224 in FIG. 2.

In operation diagram 400, a number of program operations are illustrated in sequential order. In this illustrative example, program operations in operation diagram 400 starts with a SQL read operations of “variable 1 (V1)”, “variable 2 (V2)”, and “variable 3 (V3)”. In this illustrative example, “variable 3 (V3)” can be used for determining “variable 4 (V4)” and “variable 4 (V4)” can be subsequently used for determining “variable 5 (V5)”. In operation diagram 400, “variable 3 (V3)” and “variable 4 (V4)” can be identified as variables for determining last update locations since both “variable 3 (V3)” and “variable 4 (V4)” impact downstream statements and variables.

In a similar fashion, operation diagram 402 also illustrates a number of program operations in sequential order. In this illustrative example, program operations in operation diagram 402 starts with a call to “program P1” that associated with “variable 1 (V1)”, “variable 2 (V2)”, and “variable 3 (V3)”. In a similar fashion, “variable 3(V 3 )” can be used for determining “variable 4 (V4)” and “variable 4 (V4)” can be subsequently used for determining “variable 5 (V5)”. In operation diagram 402, “variable 3 (V3)” and “variable 4 (V4)” can be identified as variables for determining last update locations since both “variable 3 (V3)” and “variable 4 (V4)” impact downstream statements and variables.

It should be understood that the illustration of operation diagram 400 and operation diagram 402 in FIG. 4 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, operation diagram 400 and operation diagram 402 can also include types of program operations other than read operations and program calls.

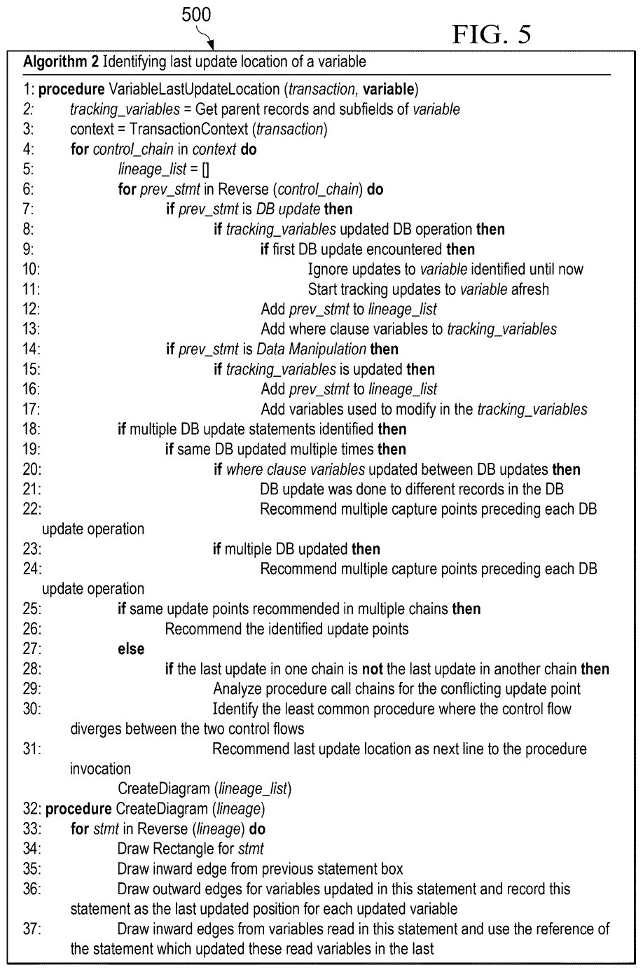

With reference now to FIG. 5, an illustration of pseudo code for an algorithm for identifying last update location of a variable is shown in accordance with an illustrative embodiment. In this example, code 500 in FIG. 5 can be implemented using program instructions 214 in FIG. 2.

In FIG. 5, code 500 illustrates steps for identifying last update locations of variables. As depicted in code 500, last update locations of variables are identified from control chains that provide data lineage information for particular variables. In this illustrative example, code 500 can be used for identifying last update locations 220 for variable 246 in FIG. 2.

It should be understood that the illustration of code 500 in FIG. 5 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, code 500 can include other programming logic for identifying last update locations of variables.

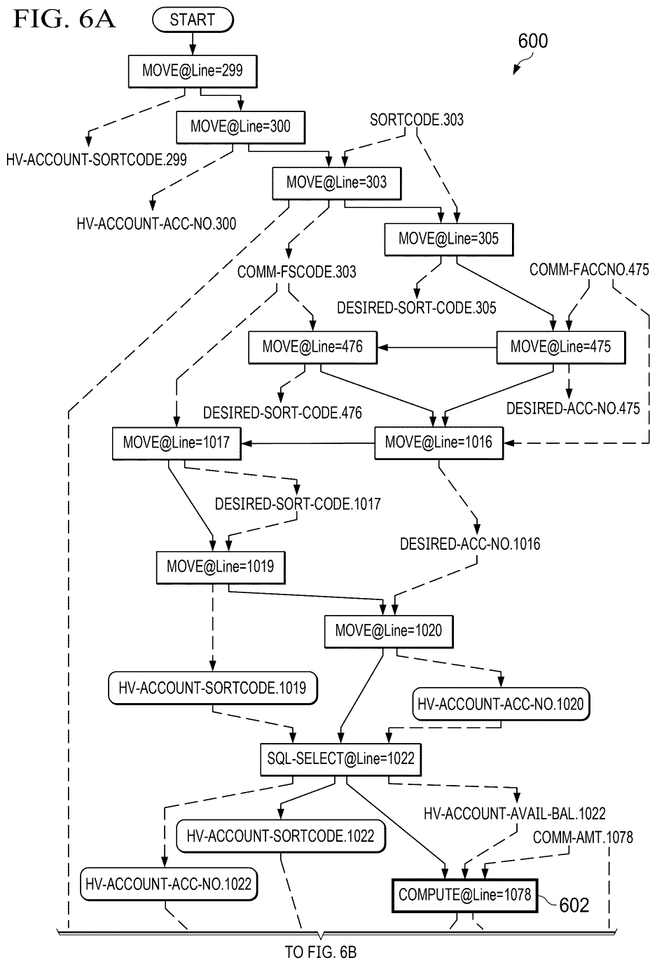

With reference now to FIG. 6A-6B, an illustration of a lineage graph is shown in accordance with an illustrative embodiment. In this example, lineage graph 600 can be examples of lineage graph 222 in FIG. 2.

In this illustrative example, lineage graph 600 shows detailed analysis of lifecycles for variable of interests to provide a visual representation of the journey that data takes through a computer system. In this illustrative example, lineage graph 600 shows relationships, transformations, and flow of data between different components in the computer system.

In this illustrative example, lineage graph 600 can be constructed using a number of statements. For example, lineage graph 600 can be constructed by identifying data manipulation statements and variables used to update variable of interests tracking their update locations. In addition, lineage graph 600 can be constructed by identifying input/output statements to identify variables used for tracking update locations for variable of interests.

As depicted, lineage graph such as lineage graph 600 can show last update locations for variable of interests in highlighted fashion. In this illustrative example, box 602 and box 604 are highlighted on lineage graph 600 to show last update locations for the variable of interests associated with lineage graph 600.

The illustration of lineage graph 600 in FIG. 6A-B is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, lifecycle for variable of interests can be present in a different way in lineage graph 600 and box 602 as well as box 604 can be highlighted in a different way compared to the method shown in lineage graph 600.

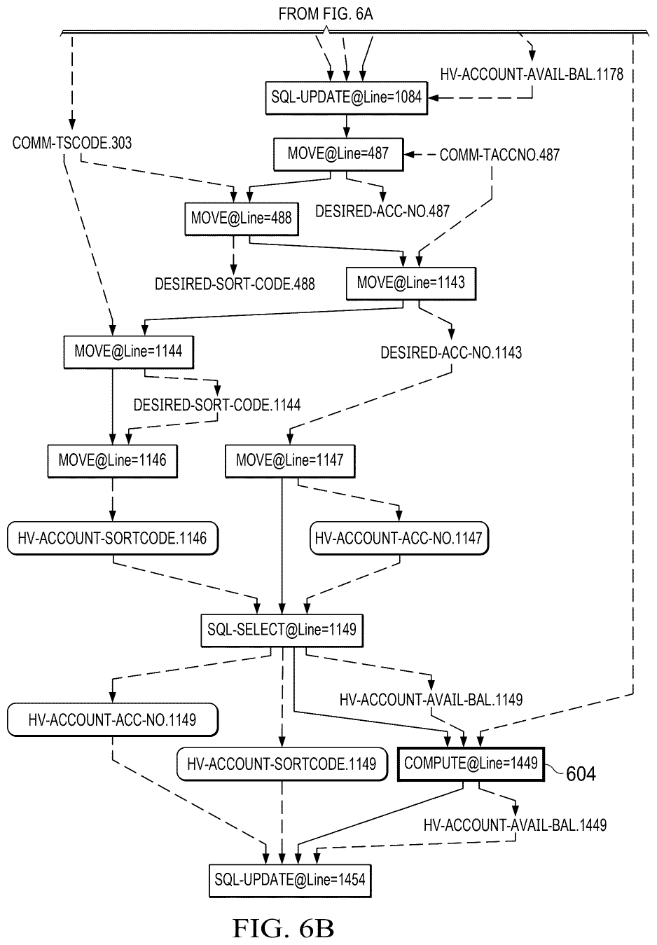

With reference now to FIG. 7, a flowchart illustrating a process for identifying update last location of variables in a computer system is shown in accordance with an illustrative embodiment. The process in FIG. 7 can be implemented in hardware, software, or both. When implemented in software, the process can take the form of program instructions that are run by one of more processor units located in one or more hardware devices in one or more computer systems. For example, the process can be implemented in data manager 212 in computer system 204 in FIG. 2.

The process begins by identifying a number of programs invoked by a transaction (step 700). In step 700, the transaction comprises a number of program operations associated with the number of programs in response of a user input from a user. The process performs analysis for the number of programs to generate a transaction diagram (step 702). In step 702, the transaction diagram comprises information associated with the number of programs for the transaction.

The process identifies a number of variables for the number of programs using the transaction diagram (step 704). The process selects a variable from the number of variables to perform a data lineage analysis for the variable (step 706). In this step, the data lineage analysis traces an entire lifecycle of the variables in the computer system. The process identifies a number of last update locations for the variable based on the data lineage analysis (step 708). The process terminates thereafter.

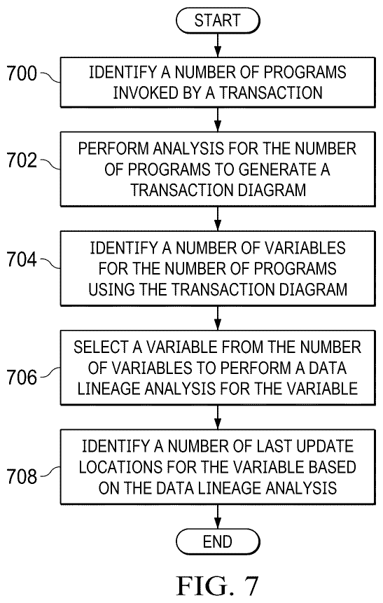

Turning next to FIG. 8, a flowchart of a process for generating a lineage graph is depicted in accordance with an illustrative embodiment. The process in this figure is an example of an additional step that can be performed with the steps in FIG. 7.

The process begins by performing a forward pass based on the transaction diagram for the transaction to identify a number of control chains where the variable is updated (step 800). The process performs a backward pass for each control chain from the number of control chains to identify the number of last update locations (step 802). The process generates a lineage graph for the variable based on the data lineage analysis (step 804). The process displays the lineage graph for the variable to the user through a graphical user interface (step 806). In this step, the number of last update locations for the variables are highlighted on the lineage graph for the variable. The process terminates thereafter.

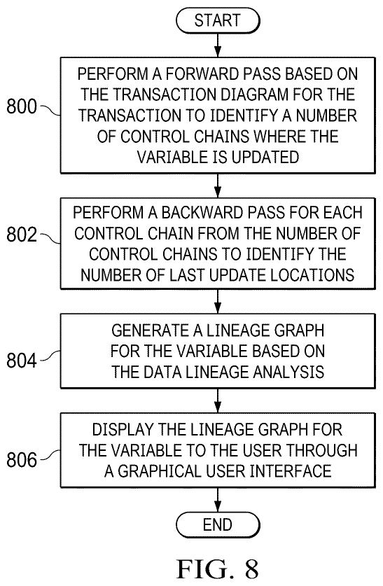

Turning next to FIG. 9, a flowchart of a process for identifying the number of programs invoked by the transaction is depicted in accordance with an illustrative embodiment. The process in this flowchart is an example of an implementation for step 700 in FIG. 7.

The process begins by identifying a starting program invoked by the transaction (step 900). In step 900, the starting program is the first program invoked by the transaction in response to the user-input. The process identifies the number of programs based on other programs invoked by the starting program (step 902). The process terminates thereafter.

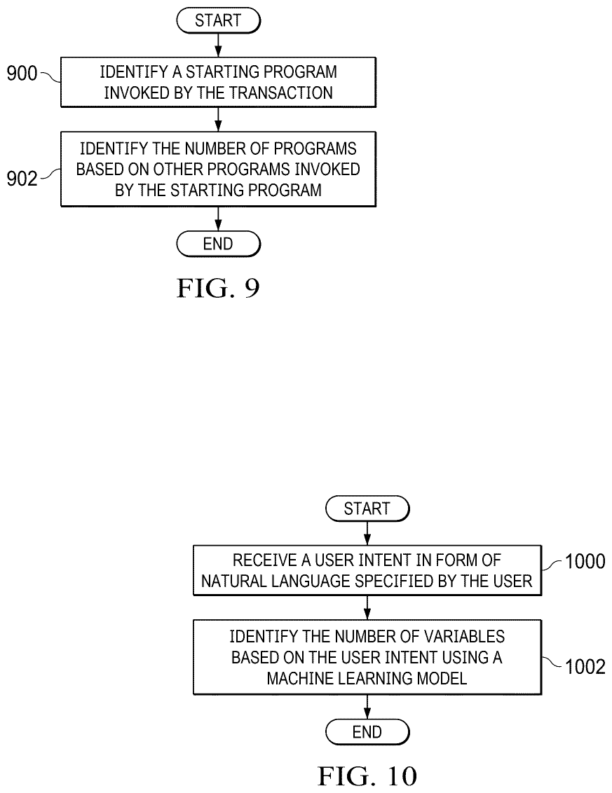

Turning next to FIG. 10, a flowchart of a process for identifying the number of variables for the number of programs using the transaction diagram is depicted in accordance with an illustrative embodiment. The process in this flowchart is an example of an implementation for step 704 in FIG. 7. In this illustrative example, the process described in FIG. 10 can be used for identifying variables 224 in FIG. 2.

The process begins by receiving a user intent in form of natural language specified by the user (step 1000). The process identifies the number of variables based on the user intent using a machine learning model (step 1002). In step 1002, the number of variables is semantically equivalent to the user intent. The process terminates thereafter.

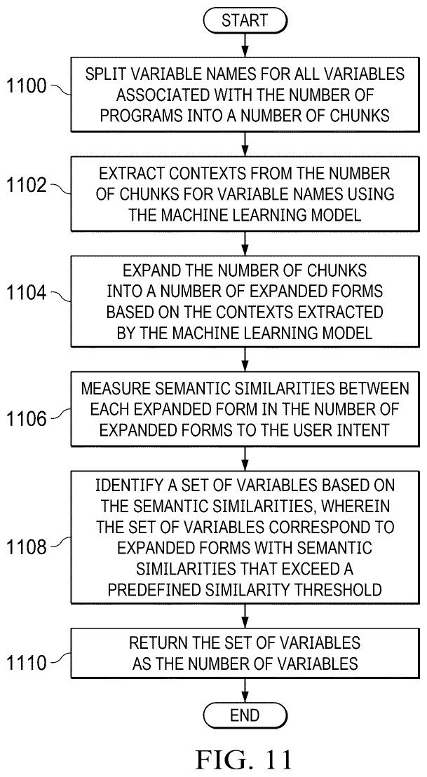

Turning next to FIG. 11, a flowchart of a process for identifying the number of variables based on the user intent is depicted in accordance with an illustrative embodiment. The process in this flowchart is an example of an implementation for step 1002 in FIG. 10.

The process begins by splitting variable names for all variables associated with the number of programs into a number of chunks (step 1100). The process extracts contexts from the number of chunks for variable names using the machine learning model (step 1102). The process expands the number of chunks into a number of expanded forms based on the contexts extracted by the machine learning model (step 1104). The process measures semantic similarities between each expanded form in the number of expanded forms to the user intent (step 1106).

The process identifies a set of variables based on the semantic similarities, wherein the set of variables correspond to expanded forms with semantic similarities that exceed a predefined similarity threshold (step 1108). The process returns the set of variables as the number of variables (step 1110). The process terminates thereafter.

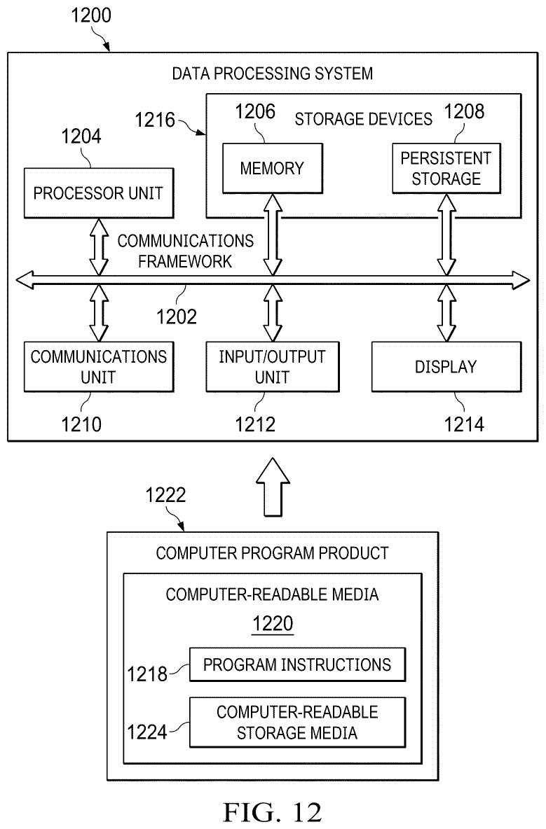

Turning now to FIG. 12, a block diagram of a data processing system is depicted in accordance with an illustrative embodiment. Data processing system 1200 can be used to implement computers and computing devices in computing environment 100 in FIG. 1. Data processing system 1200 can also be used to implement computer system 204 in FIG. 2. In this illustrative example, data processing system 1200 includes communications framework 1202, which provides communications between processor unit 1204, memory 1206, persistent storage 1208, communications unit 1210, input/output (I/O) unit 1212, and display 1214. In this example, communications framework 1202 takes the form of a bus system.

Processor unit 1204 serves to execute instructions for software that can be loaded into memory 1206. Processor unit 1204 includes one or more processors. For example, processor unit 1204 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1204 can be implemented using one or more heterogeneous processor systems in which a main processor is present with secondary processors on a single chip. As another illustrative example, processor unit 1204 can be a symmetric multi-processor system containing multiple processors of the same type on a single chip.

Memory 1206 and persistent storage 1208 are examples of storage devices 1216. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1216 may also be referred to as computer-readable storage devices in these illustrative examples. Memory 1206, in these examples, can be, for example, a random-access memory or any other suitable volatile or non-volatile storage device. Persistent storage 1208 may take various forms, depending on the particular implementation.

For example, persistent storage 1208 may contain one or more components or devices. For example, persistent storage 1208 can be a hard drive, a solid-state drive (SSD), a flash memory, a rewritable optical disk, a rewritable magnetic tape, or some combination of the above. The media used by persistent storage 1208 also can be removable. For example, a removable hard drive can be used for persistent storage 1208.

Communications unit 1210, in these illustrative examples, provides for communications with other data processing systems or devices. In these illustrative examples, communications unit 1210 is a network interface card.

Input/output unit 1212 allows for input and output of data with other devices that can be connected to data processing system 1200. For example, input/output unit 1212 may provide a connection for user input through at least one of a keyboard, a mouse, or some other suitable input device. Further, input/output unit 1212 may send output to a printer. Display 1214 provides a mechanism to display information to a user.

Instructions for at least one of the operating system, applications, or programs can be located in storage devices 1216, which are in communication with processor unit 1204 through communications framework 1202. The processes of the different embodiments can be performed by processor unit 1204 using computer-implemented instructions, which may be located in a memory, such as memory 1206.

These instructions are referred to as program instructions, computer usable program instructions, or computer-readable program instructions that can be read and executed by a processor in processor unit 1204. The program instructions in the different embodiments can be embodied on different physical or computer-readable storage media, such as memory 1206 or persistent storage 1208.

Program instructions 1218 are located in a functional form on computer-readable media 1220 that is selectively removable and can be loaded onto or transferred to data processing system 1200 for execution by processor unit 1204. Program instructions 1218 and computer-readable media 1220 form computer program product 1222 in these illustrative examples. In the illustrative example, computer-readable media 1220 is computer-readable storage media 1224.

Computer-readable storage media 1224 is a physical or tangible storage device used to store program instructions 1218 rather than a medium that propagates or transmits program instructions 1218. Computer-readable storage media 1224, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1218 can be transferred to data processing system 1200 using a computer-readable signal media. The computer-readable signal media are signals and can be, for example, a propagated data signal containing program instructions 1218. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1220” can be singular or plural. For example, program instructions 1218 can be located in computer-readable media 1220 in the form of a single storage device or system. In another example, program instructions 1218 can be located in computer-readable media 1220 that is distributed in multiple data processing systems. In other words, some instructions in program instructions 1218 can be located in one data processing system while other instructions in program instructions 1218 can be located in one data processing system. For example, a portion of program instructions 1218 can be located in computer-readable media 1220 in a server computer while another portion of program instructions 1218 can be located in computer-readable media 1220 located in a set of client computers.

The different components illustrated for data processing system 1200 are not meant to provide architectural limitations to the manner in which different embodiments can be implemented. In some illustrative examples, one or more of the components may be incorporated in or otherwise form a portion of another component. For example, memory 1206, or portions thereof, may be incorporated in processor unit 1204 in some illustrative examples. The different illustrative embodiments can be implemented in a data processing system including components in addition to or in place of those illustrated for data processing system 1200. Other components shown in FIG. 12 can be varied from the illustrative examples shown. The different embodiments can be implemented using any hardware device or system capable of running program instructions 1218.

Thus, illustrative embodiments of the present disclosure provide a computer-implemented method, computer system, and computer program product for managing containers. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for identifying last update locations of variables in a computer system, the computer implemented method comprising:
identifying, by a processor set, a number of programs invoked by a transaction, wherein the transaction comprises a number of program operations associated with the number of programs in response of a user-input from a user;
performing, by the processor set, analysis for the number of programs to generate a transaction diagram, wherein the transaction diagram comprises information associated with the number of programs for the transaction;
identifying, by the processor set, a number of variables for the number of programs using the transaction diagram;
selecting, by the processor set, a variable from the number of variables to perform a data lineage analysis for the variable, wherein the data lineage analysis traces an entire lifecycle of the variables in the computer system; and
identifying, by the processor set, a number of last update locations for the variable based on the data lineage analysis.

2. The computer implemented method of claim 1, further comprising:
performing, by the processor set, a forward pass based on the transaction diagram for the transaction to identify a number of control chains where the variable is updated;
performing, by the processor set, a backward pass for each control chain from the number of control chains to identify the number of last update locations;
generating, by the processor set, a lineage graph for the variable based on the data lineage analysis; and
displaying, by the processor set, the lineage graph for the variable to the user through a graphical user interface, wherein the number of last update locations for the variables are highlighted on the lineage graph for the variable.

3. The computer implemented method of claim 1, wherein the identifying, by the processor set, the number of programs invoked by the transaction comprises:
identifying, by the processor set, a starting program invoked by the transaction, wherein the starting program is first program invoked by the transaction in response to the user-input; and
identifying, by the processor set, the number of programs based on other programs invoked by the starting program.

4. The computer implemented method of claim 1, wherein the transaction diagram comprises information related to sequence of programs invocation for the number of programs for the transaction, sequence of input/output operations performed within each program from the number of programs in a sequential fashion, conditional statements associated with the sequence of input/output operations, and commit statements associated with the number of programs.

5. The computer implemented method of claim 1, wherein the number of variables comprises variables impacted by input/output operations but are not part of input/output update operations, variables impacted by linkage section variables, and variables that are used to update other variables.

6. The computer implemented method of claim 1, wherein the identifying, by the processor set, the number of variables for the number of programs using the transaction diagram comprises:
receiving, by the processor set, a user intent in form of natural language specified by the user; and
identifying, by the processor set, the number of variables based on the user intent using a machine learning model, wherein the number of variables is semantically equivalent to the user intent.

7. The computer implemented method of claim 6, wherein the identifying, by the processor set, the number of variables based on the user intent comprises:
splitting, by the processor set, variable names for all variables associated with the number of programs into a number of chunks;
extracting, by the processor set, contexts from the number of chunks for variable names using the machine learning model;
expanding, by the processor set, the number of chunks into a number of expanded forms based on the contexts extracted by the machine learning model;
measuring, by the processor set, semantic similarities between each expanded form in the number of expanded forms to the user intent;
identifying, by the processor set, a set of variables based on the semantic similarities, wherein the set of variables correspond to expanded forms with semantic similarities that exceed a predefined similarity threshold; and
returning, by the processor set, the set of variables as the number of variables.

8. A computer system for identifying last update locations of variables in a computer system, comprising:
a processor set;
a set of one or more computer-readable storage media; and
program instructions stored on the set of one or more storage media to cause the processor set to perform operations comprising:
identifying a number of programs invoked by a transaction, wherein the transaction comprises a number of program operations associated with the number of programs in response of a user-input from a user;
performing analysis for the number of programs to generate a transaction diagram, wherein the transaction diagram comprises information associated with the number of programs for the transaction;
identifying a number of variables for the number of programs using the transaction diagram;
selecting a variable from the number of variables to perform a data lineage analysis for the variable, wherein the data lineage analysis traces an entire lifecycle of the variables in the computer system; and
identifying a number of last update locations for the variable based on the data lineage analysis.

9. The computer system of claim 8, wherein the operations further comprise:
performing a forward pass based on the transaction diagram for the transaction to identify a number of control chains where the variable is updated;
performing a backward pass for each control chain from the number of control chains to identify the number of last update locations;
generating a lineage graph for the variable based on the data lineage analysis; and
displaying the lineage graph for the variable to the user through a graphical user interface, wherein the number of last update locations for the variables are highlighted on the lineage graph for the variable.

10. The computer system of claim 8, wherein the identifying the number of programs invoked by the transaction comprises:
identifying a starting program invoked by the transaction, wherein the starting program is first program invoked by the transaction in response to the user-input; and
identifying the number of programs based on other programs invoked by the starting program.

11. The computer system of claim 8, wherein the transaction diagram comprises information related to sequence of programs invocation for the number of programs for the transaction, sequence of input/output operations performed within each program from the number of programs in a sequential fashion, conditional statements associated with the sequence of input/output operations, and commit statements associated with the number of programs.

12. The computer system of claim 8, wherein the number of variables comprises variables impacted by input/output operations but are not part of input/output update operations, variables impacted by linkage section variables, and variables that are used to update other variables.

13. The computer system of claim 8, wherein the identifying the number of variables for the number of programs using the transaction diagram comprises:
receiving a user intent in form of natural language specified by the user; and
identifying the number of variables based on the user intent using a machine learning model, wherein the number of variables is semantically equivalent to the user intent.

14. The computer system of claim 13, wherein the identifying the number of variables based on the user intent comprises:
splitting variable names for all variables associated with the number of programs into a number of chunks;
extracting contexts from the number of chunks for variable names using the machine learning model;
expanding the number of chunks into a number of expanded forms based on the contexts extracted by the machine learning model;
measuring semantic similarities between each expanded form in the number of expanded forms to the user intent;
identifying a set of variables based on the semantic similarities, wherein the set of variables correspond to expanded forms with semantic similarities that exceed a predefined similarity threshold; and
returning the set of variables as the number of variables.

15. A computer program product for identifying last update locations of variables in a computer system, comprising:
a set of one or more computer-readable storage media;
program instructions stored in the set of one or more computer-readable storage media to perform operations comprising:
identifying, by a processor set, a number of programs invoked by a transaction, wherein the transaction comprises a number of program operations associated with the number of programs in response of a user-input from a user;
performing, by the processor set, analysis for the number of programs to generate a transaction diagram, wherein the transaction diagram comprises information associated with the number of programs for the transaction;
identifying, by the processor set, a number of variables for the number of programs using the transaction diagram;
selecting, by the processor set, a variable from the number of variables to perform a data lineage analysis for the variable, wherein the data lineage analysis traces an entire lifecycle of the variables in the computer system; and
identifying, by the processor set, a number of last update locations for the variable based on the data lineage analysis.

16. The computer program product of claim 15, wherein the operations further comprise:
performing, by the processor set, a forward pass based on the transaction diagram for the transaction to identify a number of control chains where the variable is updated;
performing, by the processor set, a backward pass for each control chain from the number of control chains to identify the number of last update locations;
generating, by the processor set, a lineage graph for the variable based on the data lineage analysis; and
displaying, by the processor set, the lineage graph for the variable to the user through a graphical user interface, wherein the number of last update locations for the variables are highlighted on the lineage graph for the variable.

17. The computer program product of claim 15, wherein the identifying, by the processor set, the number of programs invoked by a transaction comprises:
identifying, by the processor set, a starting program invoked by the transaction, wherein the starting program is first program invoked by the transaction in response to the user-input; and
identifying, by the processor set, the number of programs based on other programs invoked by the starting program.

18. The computer program product of claim 15, wherein the transaction diagram comprises information related to sequence of programs invocation for the number of programs for the transaction, sequence of input/output operations performed within each program from the number of programs in a sequential fashion, conditional statements associated with the sequence of input/output operations, and commit statements associated with the number of programs.

19. The computer program product of claim 15, wherein the number of variables comprises variables impacted by input/output operations but are not part of input/output update operations, variables impacted by linkage section variables, and variables that are used to update other variables.

20. The computer program product of claim 15, wherein the identifying, by the processor set, the number of variables for the number of programs using the transaction diagram comprises:
receiving, by the processor set, a user intent in form of natural language specified by the user;
splitting, by the processor set, variable names for all variables associated with the number of programs into a number of chunks;
extracting, by the processor set, contexts from the number of chunks for variable names using a machine learning model;
expanding, by the processor set, the number of chunks into a number of expanded forms based on the contexts extracted by the machine learning model;
measuring, by the processor set, semantic similarities between each expanded form in the number of expanded forms to the user intent;
identifying, by the processor set, a set of variables based on the semantic similarities, wherein the set of variables correspond to expanded forms with semantic similarities that exceed a predefined similarity threshold; and
returning, by the processor set, the set of variables as the number of variables.
